(19) United States
(12) Patent Application Publication
(10) Pub. No.: US 2005/0104963 A1
(43) Pub. Date: May 19, 2005

(54) On-vehicle picture data transmission system, on-vehicle picture data receiving apparatus, and on-vehicle picture data transmitting apparatus

(75) Inventors: Hiroshi Nishiyama, Shizuoka (JP); Akira Norizuki, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 11/018,371

(22) Filed: Dec. 22, 2004

Related U.S. Application Data
(62) Division of application No. 09/982,771, filed on Oct. 22, 2001.

(30) Foreign Application Priority Data
Oct. 20, 2000 (JP) P. 2000-321366

(51) Int. Cl. H04N 7/18

(52) U.S. Cl. 348/148

(57) ABSTRACT

In an on-vehicle picture data transmission system, a front monitor, a rear monitor, a back-sight monitor, and also a DVD player are connected to a cable having a transfer capacity of approximately 20 Mbps. In such a case that compression data is transferred from the DVD player of a slave electronic appliance to the front monitor of a master electronic appliance and also to the rear monitor of a spare master electronic appliance at a data transfer rate of 20 Mbps, when a back gear signal produced by that a vehicle user sets a back gear is entered into the master electronic appliance, this master electronic appliance controls the data transfer rate of the picture data sent out from the DVD player to 10 Mbps, and also controls the data transfer rate of the picture data outputted from the back-sight camera to the front-sight camera to 10 Mbps.

### BACKGROUND OF THE INVENTION

The present invention relates to an on-vehicle picture data transmission system, an on-vehicle picture data receiving apparatus, and an on-vehicle picture data transmitting apparatus, in which picture data outputted from a plurality of picture sources are transferred within a vehicle.

Generally, as a data transmission system capable of transferring data within a vehicle, one data transmission system in which a command and audio data are transferred by using this optical fiber installed in a vehicle is known.

In this data transmission system, for example, an audio reproducing apparatus mounted in the vicinity of a front sent (driver seat) is connected to a speaker apparatus mounted in the vicinity of a rear seat (passenger seat) by employing an optical fiber cable. In this data transmission system, for example, audio data recorded on a disk-shaped recording medium is reproduced by the audio reproducing apparatus, and then, the reproduced audio data is transferred to the speaker apparatus mounted on the rear seat via the optical fiber cable so as to hear audio sound by an audience.

In the above-described data transmission system, there are many possibilities that the data to be transferred is audio data and the like, and these data own such transfer rates lower than or equal to the data transmission band of the optical fiber cable. However, in the general data transmission system, practically speaking, no trial has been carried out to transfer data having a large data amount, e.g., picture data by using a transfer rate higher than or equal to the data transmission band of the optical fiber.

### SUMMARY OF THE INVENTION

As a consequence, the present invention has been made to solve the above-explained problem, and therefore, has an object to provide an on-vehicle picture data transmission system, and an on-vehicle picture data receiving apparatus, capable of transferring picture data, while managing a use range of a communication cable provided in a vehicle.

Also, another object of the present invention is to provide an on-vehicle picture data transmitting apparatus capable of transferring picture data in an optimum compression system, while selecting an optimum picture source.

In order to solve the aforesaid object, the invention is characterized by having the following arrangement.
(1) A non-vehicle picture data transmission system to which a plurality of picture sources are connected via a vehicle-inside communication line, comprising:
   a plurality of picture transmitting apparatuses, each of the plurality of picture transmitting apparatus including,
      an input unit for inputting a picture signal from the plurality of picture sources,
      a data converter for converting the picture signal from the input unit into picture data having a predetermined transfer rate,
      a transmission unit for transmitting the picture data converted by the data converter to the vehicle-inside communication line, and
      a rate controller for controlling the data converter to control the transfer rate;
   a plurality of picture receiving apparatus, each off the plurality of picture receiving apparatus including,
      a reception unit for receiving the picture data transmitted from the picture transmitting unit via the vehicle-inside communication line,
      a data converter for converting the picture data from the reception unit into a picture signal,
      an output unit for outputting the picture signal converted by the data converter, and
      a line management unit for outputting a control signal to the rate controller, the control signal designating the transfer rate of the picture data transferred via the vehicle-inside communication line; and
   a provision unit for providing information, which the picture signal from the output unit of the picture receiving apparatus represents, with a user in the vehicle,
   wherein the line management unit outputs to the rate controller, a control signal capable of controlling the transfer rate of the picture data from each of the picture transmitting apparatus to the vehicle-inside communication line, based upon transfer capacity information indicative of a transfer capacity of the vehicle-inside communication line and transfer rate information indicative of a transfer rate used in the vehicle-inside communication line, and
   wherein the rate controller controls the data converter so that the transfer rate at which the picture data is transmitted by the transmission unit is controlled based upon the control signal for controlling the transfer rate from the line management unit.
(2) The on-vehicle picture data transmission system according to (1), wherein
   the picture source is constituted by a rear monitoring camera apparatus for monitoring a rear-sight of the vehicle, and
   the line management unit controls a transfer rate of picture data transmitted from the rear monitoring camera apparatus and a transfer rate of picture data transmitted from another picture transmitting apparatus via the vehicle-inside communication line so that the provision unit provides the information of the picture data imaged by the back-sight monitoring camera apparatus based upon a back gear signal produced when the user sets a back gear.
(3) An on-vehicle picture data receiving apparatus for receiving picture data via a vehicle-inside communication line from a plurality of picture transmitting apparatus which converts picture signal from a picture source into the picture data having a transfer rate used when the picture data is transmitted via the vehicle-inside communication line, the on-vehicle picture data receiving apparatus comprising:
   a reception unit for receiving the picture data transmitted from each of the picture transmitting apparatus via the vehicle-inside communication line;
   a data converter for converting the picture data received by the reception unit into a picture signal;
   an output unit for outputting the picture signal converted by the data converter to provide contents of the picture signal to a user in a vehicle; and
   a line management unit for outputting to the picture transmitting apparatus, a control signal for designating a transfer rate of the picture data transferred via the vehicle-inside communication line,
   wherein the line management unit controls the transfer rate of picture data from each of the picture transmitting apparatus via the vehicle-inside communication line, based upon transfer capacity information indicative of a transfer capacity of the vehicle-inside communication line and transfer rate information indicative of a transfer rate used in the vehicle-inside communication line.
(4) The on-vehicle picture data receiving apparatus according to (3), wherein
   the picture source is constituted by a rear monitoring camera apparatus for monitoring a rear-sight of the vehicle, and
   the line management unit controls a transfer rate of picture data transmitted from the rear monitoring camera apparatus to the vehicle-inside communication line and a transfer rate of picture data transmitted from another picture transmitting apparatus so that the provision unit provides the information of the picture data imaged by the back-sight monitoring camera apparatus when a back gear signal is produced when the user sets a back gear.
(5) An on-vehicle picture data transmitting apparatus comprising:
   a picture input unit for inputting picture data supplied from a plurality of picture sources which are externally connected;
   a transmission reception unit for receiving vehicle information indicative of a condition of a vehicle, and for transmitting picture data via a communication line to a picture display apparatus;
   a compressing processor having a plurality of compressing process units, compression systems of which are different from each other;
   a selection unit for receiving a plurality of picture data from the picture input unit, and for selectively outputting the picture data from the picture source designated based upon a picture source selection signal to the compressing process unit in response to a compression selection signal; and
   a controller for producing the picture source selection signal and the compression selection signal and controlling the compression system based upon the vehicle information to control the selection unit.
(6) The on-vehicle picture data transmitting apparatus according to (5), wherein
   the controller produces the compression selection signal for each of the picture data based upon an image quality required for each of the picture sources.
(7) The on-vehicle picture data transmitting apparatus according to (5), wherein
   the transmission reception unit is connected to a master electronic appliance for monitoring a communication traffic within the vehicle, and receives vehicle information indicative of a communication traffic of a communication line from the master electronic appliance contained in a network; and
   the controller produces the compression selection signal for switch the compression systems of the respective picture data based upon the vehicle information indicative of the communication traffic received from the transmission reception unit.
(8) The on-vehicle picture data transmitting apparatus according to (5), wherein
   the controller produces the compression selection signal for switching the compression system of the picture data based upon a setting position of the picture display apparatus.
(9) The on-vehicle picture data transmitting apparatus according to (5), wherein
   the transmission reception unit is connected to an operation input device which is operated by a user in the vehicle, and receives an operation input signal supplied from the operation input device, and
   the controller produces the picture source selection signal and the compression selection signal based upon the operation input signal to control the selection unit.
(10) The on-vehicle picture data transmitting apparatus according to (5), wherein
   the transmission reception unit is connected to a sensor for sensing a condition of the vehicle; and
   the controller produces the compression selection signal based upon a sensor signal from the sensor.
(11) The on-vehicle picture data transmitting apparatus according to (5), wherein
   the controller produces the compression selection signal for switching the compression system based upon vehicle information indicative of a drive condition of the vehicle.

In accordance with the on-vehicle picture data transmission system as recited in (1) of the present invention, the control signal is outputted to the data transmission side, and the transfer rate when the picture data is transmitted. This control signal may control the transfer rate of the picture data which is transmitted from the respective picture transmitting processor to the vehicle communication line based upon both the transfer capacity information indicative of the transfer capacity of the vehicle-inside communication line, and also the transfer rate information which indicates the transfer rate used in the vehicle-inside communication line. As a consequence even when such a communication line is provided in the vehicle, the transfer rate of which is limited, the picture data can be transferred and the contents of this picture data can be provided to the user.

In accordance with the on-vehicle picture data transmission system as recited in (2) of the present invention, the transmission band of the necessary picture data can be secured in response to the back gear signal, and while the used range of the communication cable installed inside the vehicle is managed, the picture data can be transferred.

In accordance with the on-vehicle picture data transmission system as recited in (3) of the present invention, even when the transfer capacity of the communication line is limited, the transfer rate information is obtained so as to control the transfer rate used in the case that a plurality of picture transmitting apparatus transmit the picture data. As a result, while the used range of the communication cable installed inside the vehicle is managed, the picture data can be transferred.

In accordance with the on-vehicle picture data transmission system as recited in (4) of the present invention, the transmission band of the necessary picture data can be secured in response to the back gear signal and while the used range of the communication cable installed inside the vehicle is managed, the communication data can be transferred.

In accordance with the on-vehicle picture data transmitting apparatus as recited in (5) of the present invention, the picture source is selected based upon the condition of the vehicle, and further, the compression system used when the picture data is transmitted from the selected picture source via the communication line is selected. As a result, while the optimum picture source is selected in accordance with the condition of the vehicle, the picture data can be transferred with the optimum compression system.

In accordance with the on-vehicle picture data transmitting apparatus as recited in (6) of the present invention, the picture data supplied from the respective picture sources are compressed by the different compression systems so as to determine the image quality. As a consequence, the picture data can be transferred with the optimum compression system selected in accordance with the picture source.

In accordance with the on-vehicle picture data transmitting apparatus as recited in (7) of the present invention, the picture data having the transfer rate is transmitted, while this transfer rate is determined in response to the entire communication traffic of the network. As a result, the picture data can be transferred with the optimum compression system in response to the condition of the traffic.

In accordance with the on-vehicle picture data transmitting apparatus as recited in (8) of the present invention, the pictures are provided, while these pictures are compressed by the different compression systems in accordance with the vehicle driver who monitors the respective picture display apparatus.

In accordance with the on-vehicle picture data transmitting apparatus as recited in (9) of the present invention, the picture data supplied from the picture source selected in response to the operation by the user is compressed by the compression system in accordance with the operation of the user. As a result, while the optimum picture source is selected in accordance with the operation by the user, the picture data can be transferred with the optimum compression system.

In accordance with the on-vehicle picture data transmitting apparatus as recited in (10) of the present invention, the picture data can be transferred with the optimum compression system selected in accordance with the condition of the vehicle.

In accordance with the on-vehicle picture data transmitting apparatus as recited in (11) of the present invention, the picture data is compressed by the compression system in accordance with the driving speed and the driving condition of the vehicle. As a result, while the optimum picture source is selected in accordance with the condition of the vehicle, the picture data can be transferred with the optimum compression system.

### BRIEF DESCRIPTION OF THE DRAWINGS

FIG. 1 is a block diagram for representing an arrangement of an on-vehicle picture data transmission system to which the present invention is applied.

FIG. 2 is a block diagram for showing an arrangement of a picture receiving processor and an arrangement of a picture transmitting processor.

FIGS. 3A and 3B are diagrams for showing display screens displayed on both a front monitor and a rear monitor; FIG. 3A shows a normal screen and FIG. 3B indicates a picture selection screen.

FIG. 4 is a diagram for representing other picture selection screens which are displayed on both the front monitor and the rear monitor.

FIG. 5 is a flow chart for describing an example of a resource management executed by the on-vehicle picture data transmission system to which the present invention is applied.

FIG. 6 is a block diagram for representing an arrangement of another on-vehicle picture data transmission system to which the present invention is applied.

FIG. 7 is a block diagram for indicating an arrangement of an extension box to which the present invention is applied.

FIG. 8 is a diagram for explaining compression systems executed in the respective compressing process units of the extension box to which the present invention is applied.

FIG. 9 is a diagram for indicating delay allowable values with respect to the picture sources.

FIG. 10 is a diagram for showing an example of determining both compression systems and compression rates of the respective picture sources based upon a plurality of parameters in the extension box to which the present invention is applied.

### DETAILED DESCRIPTION OF THE PREFERRED EMBODIMENTS

Referring now to drawings, embodiments of the present invention will be described.

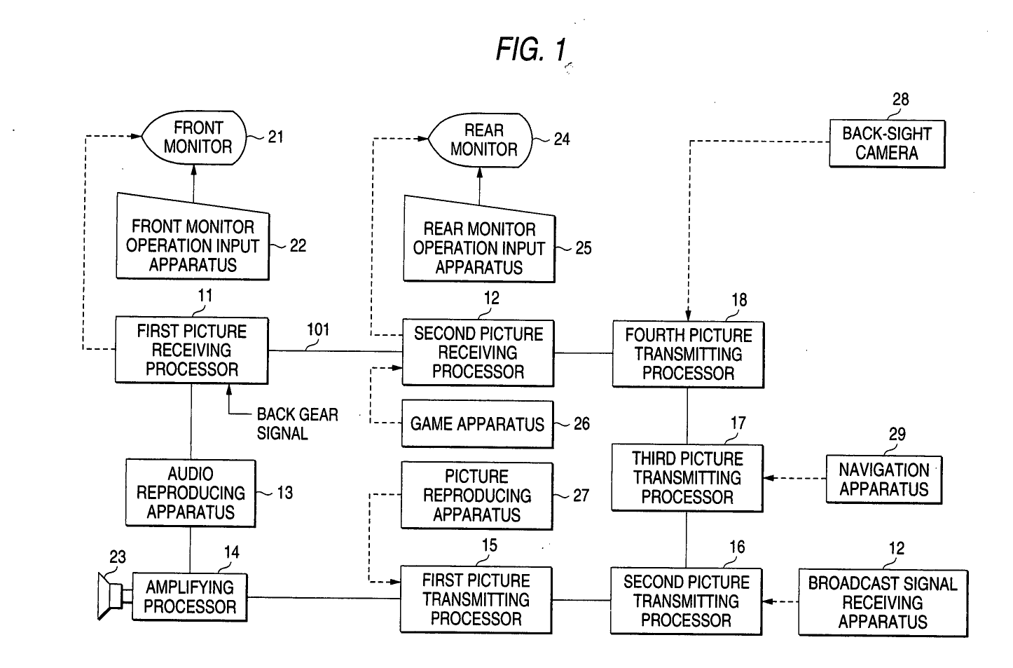

The present invention is applied to, for example, an on-vehicle picture data transmission system shown in FIG. 1. In this on-vehicle picture data transmission system, this data transmission system is constructed in such a manner that a plurality of picture sources and a plurality of reception terminals are connected to each other on a network. For example, as shown in FIG. 1, the data transmission system is equipped with, as the picture sources, a game apparatus 26, a picture reproducing apparatus 27 such as a DVD (Digital Video Disc) player, a back-sight camera 28, a navigation apparatus 29, and a broadcast signal receiving apparatus 30 having a TV tuner. An embodiment provided with a front monitor 21 and a back-sight monitor 24 as the picture sources will is described hereinafter for the explanation of the present invention.

This on-vehicle picture data transmission system is arranged in such a manner that a first picture receiving processor 11, a second picture receiving processor 12, an audio reproducing apparatus 13, an amplifying processor 14, a first picture transmitting processor 15, a second picture transmitting processor 16, a third picture transmitting processor 17, and a fourth picture transmitting processor 18 are connected to each other by employing a single cable 101, and these processor are mounted within a vehicle. The cable 101 employed in this on-vehicle picture data transmission system is made of, for example, an optical fiber. This optical fiber owns a predetermined data transfer capacity, for instance, on the order of 22 Mbps. It should be noted that in FIG. 1, the cable 101 which is used to connect the respective units which constitute the on-vehicle picture data transmission system are shown by a solid line, and a transfer line of an analog signal is denoted by a dotted line.

This on-vehicle picture data transmission system is provided with the front monitor 21 and a front monitor operation input unit 22 which are connected to the first picture receiving processor; an acoustic output unit 23 connected to the amplifying processor 14; the rear monitor 24, a rear-sight operation input unit 25 and the game apparatus 26 which are connected to the second picture receiving processor 12; a picture reproducing apparatus 27 connected to the first picture transmitting processor 15; the back-sight camera 28 connected to the fourth picture transmitting apparatus 18; the navigation apparatus 29 connected to the third picture transmitting processor 17; and the broadcast signal receiving apparatus 30 connected to the second picture transmitting processor 16.

In this on-vehicle picture data transmission system, the front monitor 21, the front monitor operation input unit 22, the first picture receiving processor 11, the audio reproducing apparatus 13, the amplifying processor 14, and the acoustic output unit 23 are installed on the side of such a user who uses the front seat within the vehicle. The front monitor operation input unit 22, the audio reproducing apparatus 13, and the amplifying processor 14 are operated by the user who uses the front seat.

In this on-vehicle picture data transmission system, the rear monitor 24, the rear monitor operation input unit 25, the second picture receiving processor 12, the game apparatus 26, the picture reproducing apparatus 27, and the first picture transmitting processor 15 are installed on the side of such users who uses the rear seat at the rear portion of the vehicle. The rear monitor operation input unit 25, the game apparatus 26, and the picture reproducing apparatus 27 are operated by the user who uses the rear seat.

In the on-vehicle picture data transmission system, the back-sight camera 28, the fourth picture transmitting processor 18, the navigating apparatus 29, the third picture transmitting processor 17, the broadcast signal receiving apparatus 30, and the second picture transmitting processor 16 are installed at a rear portion of the rear seat.

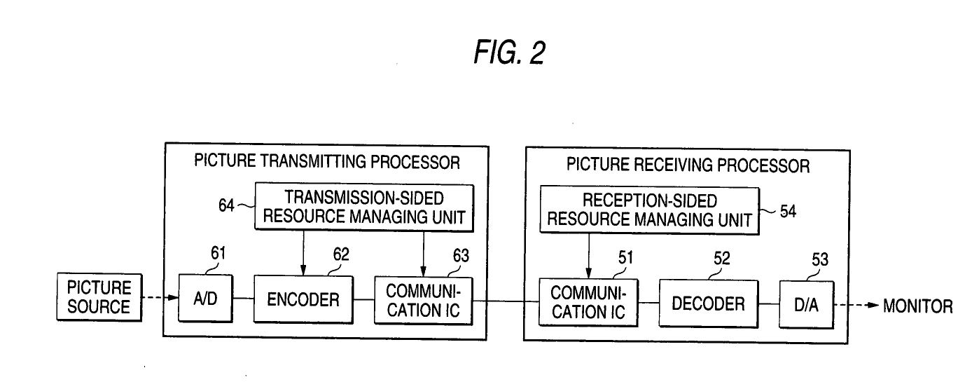

Both the first picture receiving apparatus 11 and the second picture receiving apparatus 12 are simply referred to a “picture receiving processor” hereinafter as a generic name. The first picture transmitting processor 15, the second picture transmitting processor 16, the third picture transmitting processor 17, and the fourth picture transmitting processor 18 are simply referred to a “picture transmitting processor” hereinafter as a generic name. The picture receiving processor and the picture transmitting processor are arranged as shown in FIG. 2.

The picture receiving apparatus is provided with a communication IC (Integrated Circuit) 51, a decoder 52, a D/A converting circuit 53, and a reception-side resource managing unit 54, which are connected to each other by using the cable 101. The decoder 52 decodes picture data received by the communication IC 51. The D/A converting circuit 53 D/A-converts the picture data decoded by the decoder 52. The reception-sided resource managing unit 54 controls the transmission band of the entire on-vehicle picture data transmission system.

The communication IC 51 executes such a process operation that the communication IC 51 receives picture data, a command, and various sorts of information, which are inputted thereinto via the cable 101, and then converts these input items into such picture data, command and various sorts of information which own predetermined formats. These formats may be processed by the picture receiving processor. This communication IC 51 performs another process operation that a command entered from the reception-sided resource managing unit 54, and a command entered from an external source are transmitted to other electronic appliances.

The communication IC 51 performs the following process operations. That is, in the case that the cable 101 is made of an optical fiber cable, an optical signal is converted into an electric signal and then this electric signal is outputted to the decoder 52. Further, the communication IC 51 converts an electric signal into an optical signal, and then sends out the optical signal to the cable 101.

The decoder 52 performs such a decode process operation with respect to picture sent from the communication IC 51, and thereafter, outputs the decoded picture data to the D/A converting circuit 53. This decoder 52 decodes, for example, compressed picture data to produce non-compressed picture data.

The D/A converting circuit 53 performs a D/A converting process operation with respect to picture data supplied from the reception-sided resource managing unit 54, and then, outputs a converted picture signal to an electric appliance connected thereto.

The reception-sided resource managing unit 54 executes a resource management process operation in such a manner that a used transmission rate is adjusted within a data transfer capacity. This used transfer rate indicates such a transfer rate which is presently used by the cable 101.

The reception-sided resource managing unit 54 holds both data transfer capacity information and used data transfer rate information. This data transfer capacity information indicates a data transfer capacity of the cable 101 under which data can be transferred through the cable 101 at maximum when the on-vehicle picture data transmission system is operated. The used transfer rate information indicates such a data transfer rate under which the cable 101 is presently used. This reception-sided resource managing unit 54 allocates a used transfer rate to each of the picture resources based upon the used transfer rate information stored therein. The reception-sided resource managing unit 54 transmits a control signal for designating such a used transfer rate to each of the picture transmitting processor contained in the on-vehicle picture data transmission system.

The picture transmitting processor is provided with an analog-to-digital (A/D) converting circuit 61, an encoder 62, a communication IC 63, and a transmission-sided resource managing unit 64. The A/D converting circuit 61 is connected to a picture source, for example, the above-explained picture reproducing apparatus 27, and A/D-converts an analog picture signal entered from the picture source into picture data. The encoder 62 encodes the picture data supplied from the A/D converting circuit 61. The communication IC 63 is connected to the cable 101. The transmission-sided resource managing unit 64 controls the used transfer rate.

The analog picture signal from the picture source is inputted to the A/D converting circuit 61, and this A/D converting circuit 61 executes the A/D converting process operation with respect to this analog picture signal, and then, outputs the picture data into the encoder 62.

The encoder 62 encodes the analog picture signal supplied from the A/D converting circuit 61, and then outputs the encoded picture data to the communication IC 63. The encoder 62 encodes the analog picture signal in response to a control signal supplied from the transmission-sided resource managing unit 64.

The communication IC 63 sends out the picture data from the encoder 62 to the cable 101 in response to a control signal supplied from the transmission-sided resource managing unit 64. In the case that the cable 101 is made of, for example, an optical fiber cable, the communication IC 63 performs such a process operation for converting an electric signal into an optical signal.

In such an on-vehicle picture data transmission system, any one of the picture receiving processor constitutes a master electronic appliance, whereas both other picture receiving processor and the picture transmitting processor constitute slave electronic appliances. The master electronic appliance manages the used transfer rate within the on-vehicle picture data transmission system, and the used transfer rates of the slave electronic appliances are controlled by the master electronic appliance.

Specifically, in the case that to a transmission request of picture data is inputted from the slave electronic appliance via the cable 101 and the communication IC 51, the reception-sided resource managing unit 54 of the picture receiving processor which constitutes the master electronic appliance transmits a control signal to the picture transmitting processor which has issued the transmission request. This control signal may designate the used transfer rate based upon the presently used transfer rate and the data transfer capacity. In response to the control signal, the transmission-sided resource managing unit 64 of the slave electronic appliance which has received the control signal controls the encoder 62 in such a manner that this encoder 62 performs such a compression process operation at the transfer rate of the designated used transfer rate. As a result, the cable 101 can transfer a plurality of picture data which are produced by a plurality of picture sources within a predetermined transfer rate.

The front monitor 21 receives the picture data, transferred within the on-vehicle picture data transmission system, from the D/A converting circuit 53 of the first picture receiving processor 11, and displays the contents of the picture data so as to provide this displayed contents to the user who utilizes the front seat.

The front monitor operation input unit 22 is provided with an operation button and an operation dial which are operated by the user who monitors the front monitor 21, and produces an operation input signal when the user operates the operation button and the operation dial. This front monitor operation input unit 22 produces an operation input signal which is used to control the picture contents displayed on the front monitor 21. Specifically, this front monitor operation input unit 22 displays a contents of a desirable sort of a picture contents according to the operation input signal for selecting the picture source produced by the front monitor operation input unit 22.

The rear monitor 24 receives the picture data, transferred within the on-vehicle picture data transmission system, from the D/A converting circuit 53 of the first picture receiving processor 11, and displays the contents of the picture data so as to provide this displayed contents to the user who utilizes the rear seat.

The rear monitor operation input unit 25 is provided with an operation button and an operation dial which are operated by the user who monitors the rear monitor 24, and produces an operation input signal when the user operates the operation button and the operation dial. This rear monitor operation input unit 25 produces an operation input signal which is used to control the picture contents displayed on the rear monitor 24. Specifically, this rear monitor operation input unit 25 displays a contents of a desirable sort of a picture contents according to the operation input signal for selecting the picture source produced by the rear monitor operation input unit 25.

The audio reproducing apparatus 13 can mount an information reading medium such as a compact disk, and perform a process operation for reproducing an audio signal which has been recorded on the information recording medium mounted on this audio reproducing apparatus 13. The audio reproducing apparatus 13 executes a process operation for sending out the reproduced audio signal to the cable 101. This audio reproducing apparatus 13 performs a reproducing process operation in response to either an operation input signal from the front monitor operation input unit 22 or an operation input signal from the rear monitor operation input unit 25.

The amplifying processor 14 executes an amplifying process operation with respect to the audio data inputted via the cable 101, and outputs the amplified audio data to the audio reproducing apparatus 13 so as to cause the acoustic output unit 23 to produce acoustic sound. The amplification degree of the amplifying processor 14 is designated in response to either an operation input signal from the front monitor operation input unit 22 or an operation input signal from the rear monitor operation apparatus 25.

The picture reproducing apparatus 27, the broadcast signal receiving apparatus 30, the navigation apparatus 29, and the back-sight camera 28 are connected to the first picture transmitting processor 15, the second picture transmitting processor 16, the third picture transmitting processor 17, and the fourth picture transmitting processor 18 as the picture source. Respective first to fourth picture transmitting processor 15 to 18 receives an operation input signal for controlling operation of each of the picture sources inputted by either the rear monitor operation input unit 25 or the front monitor operation input unit 22, and then, the operation input signal is outputted to the picture source. Each of the picture transmitting processor 15 to 18 performs compressing process operation in accordance with the used transfer rate information designated by the master electronic appliance by the encoder 62.

The picture reproducing apparatus 27 is constructed by, for example, a DVD player, and reproduces picture data recorded on the information recording medium in response to an operation input signal so as to produce an analog type picture signal to be outputted to the first picture transmitting processor 15.

The broadcast signal receiving apparatus 30 receives various broadcast signals, performs such a process operation that a desirable broadcast signal is tuned and extracted in response to an operation input signal, and then outputs both the picture (video) signal and the audio signal, which are extracted, to the second picture transmitting processor 16. This broadcast signal receiving apparatus 30 receives either an operation input signal from the front monitor operation input unit 22 or an operation input signal derived from the rear monitor operation input unit 25 via the second picture transmitting processor 16, and selects a desired broadcast signal which to extract picture data from the selected broadcast signal.

The navigation apparatus 29 can execute a process operation for reading map data from an information recording medium, a process operation for displaying a present position on a map, a process operation for designating an optimum path, and the like. This navigation apparatus 29 outputs picture data indicative of a map to the third picture transmitting processor 17.

The back-sight camera 28 is provided with a back-sight monitoring CCD (Charge-Coupled Device) imaging element, or the like. This CCD imaging element is exposed backwardly from the vehicle, and is to monitor a back-sight of the vehicle. This back-sight camera 28 outputs a camera signal obtained by imaging a back sight to the fourth picture transmitting process operation 18. This back-sight camera 28 starts the imaging operation of the back sight of the vehicle in response to aback gear signal, and then, supplies the picture data obtained by imaging the back sight to the fourth picture transmitting processor 18. This back gear signal indicates that the user sets the back gear of the vehicle.

Next, a description will now be made of an example in the case that pictures supplied from a plurality of picture sources are displayed on either the front monitor 21 or the rear monitor 24. In this example case, the first picture receiving processor 11 constitutes a master electronic appliance, whereas both the second picture receiving processor 12 and the respective picture transmitting processor constitute slave electronic appliances.

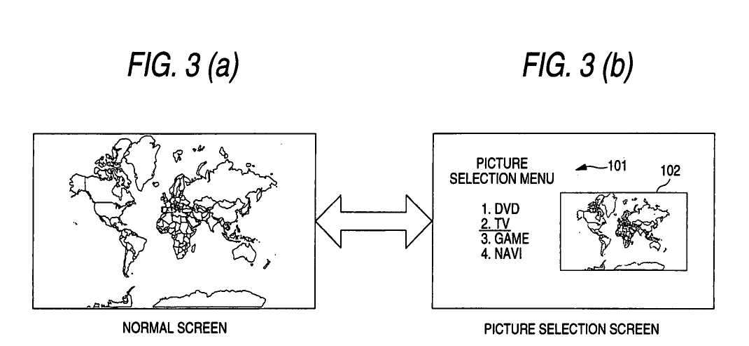

Either the front monitor 21 or the rear monitor 24 displays either a normal screen or a picture selection screen in response to data supplied from either the first picture receiving apparatus 11 or the second picture receiving processor 12. The normal screen displays a single picture over the entire screen as indicated in FIG. 3A. The picture selection screen is used to select a picture source as indicated in FIG. 3B. Either the front monitor 21 or the rear monitor 24 selectively displays the normal screen or the picture selection screen in response to either an operation input signal from the front monitor operation input unit 22 or an operation input signal from the rear monitor operation monitor apparatus 25.

Either the front monitor 21 or the rear monitor 24 displays as the picture selection both a screen selection display 101 and a selection-purpose small picture display 102. This screen selection display 101 causes the user to select any one of the picture reproducing apparatus 27 (DVD), the broadcast signal receiving apparatus 30 (TV), the game apparatus 26 (GAME), and the navigation apparatus 29 (NAVI) as the picture source. The front monitor 21, or the rear monitor 24 displays as the selection-purpose small picture display 102, a contents of picture data corresponding to the presently selected picture selection display 101.

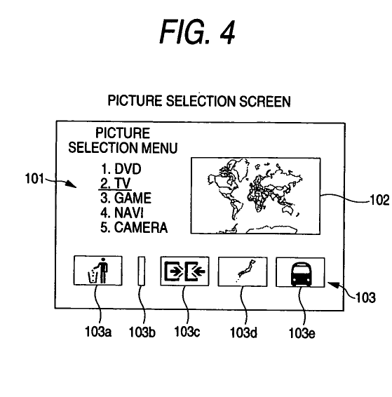

Alternatively, either the front monitor 21 or the rear monitor 24 may display a display contents as indicated in FIG. 4 as the picture selection screen. As illustrated in FIG. 4, either the front monitor 21 or the rear monitor 24 displays a transfer picture referring picture display 103 in addition to the picture selection display 101 and the selection-purpose small picture display 102. The transfer picture referring picture display 103 indicates a contents of picture data which is transferred within the on-vehicle picture data transmission system. Either the front monitor 21 or the rear monitor 24 displays the picture selection display 101 and also the transfer picture referring picture display 103 corresponding to the respective picture sources. This screen selection display 101 causes the user to select any one of the picture reproducing apparatus 27 (DVD), the broadcast signal receiving apparatus 30 (TV), the game apparatus 26 (GAME), and the navigation apparatus 29 (NAVI), and also the back-sight camera 28 (CAMERA) as the picture source.

Either the front monitor 21 or the rear monitor 24 displays as the transfer picture referring picture display 103, a small picture display 103a representing a contents of picture data outputted from the picture reproducing apparatus 27, another small picture display 103b representing a contents of picture data outputted from the broadcast signal receiving apparatus 30, another small picture display 103c representing a contents of picture data outputted from the game apparatus 26, another small picture display 103d representing a contents of picture data outputted from the navigation apparatus 29, and a further small picture display 103e representing a contents of picture data outputted from the back-sight camera 28.

In the case that the respective small picture displays are represented, the reception-sided resource managing unit 54 of the master electronic appliance controls to transfer the picture data outputted from the respective picture sources under data transfer rate of 4 Mbps.

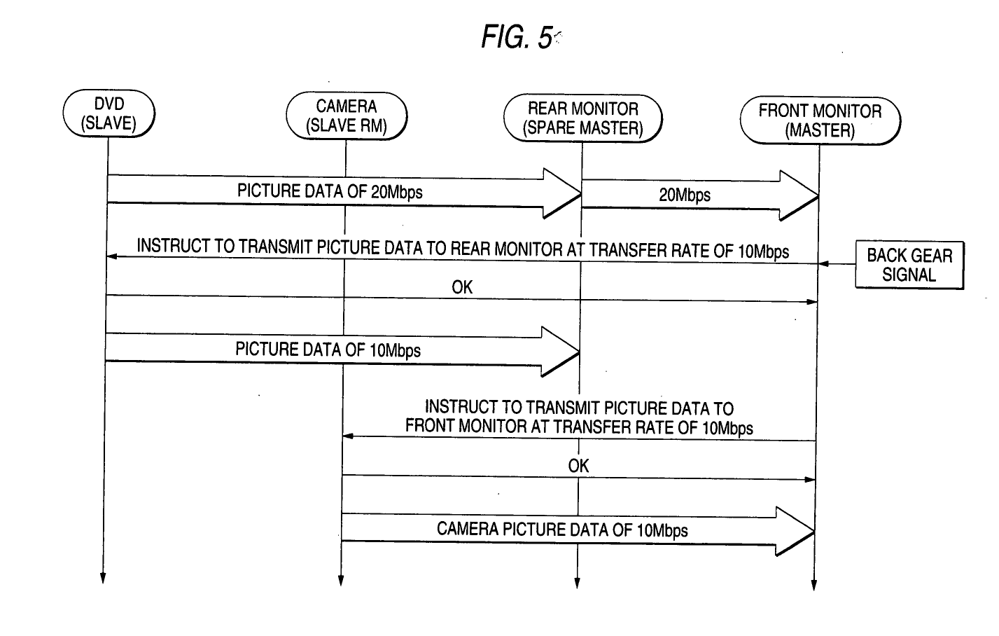

Next, a description will now be made of one example when a resource management of the on-vehicle picture data transmission system is carried out with reference to FIG. 5. FIG. 5 explains such an example that the first picture receiving processor 11 connected to the front monitor 21 constitutes a master electronic appliance, the second picture receiving processor 12 connected to the front monitor 21 constitutes a spare master electronic appliance, and both the fourth picture transmitting processor 18 connected to the back-sight camera 28 and the first picture transmitting processor 15 connected to the picture reproducing apparatus 27 constitute slave electronic appliances. In this case, when a plurality of master electronic appliances are present within the on-vehicle picture data transmission system, one of these plural master electronic appliances constitutes a master electronic appliance, and other electronic appliances constitute spare master electronic appliances.

In FIG. 5, in the case that picture data is transferred from the picture reproducing apparatus 27 to both the front monitor 21 and the rear monitor 24 at the data transfer rate of 20 Mbps, when the back gear signal is inputted into the first picture receiving processor 11, the first picture receiving processor 11 controls to display the picture data photographed by the back-sight camera 28 on the front monitor 21.

At this time, the first picture receiving processor 11 first outputs a transmission instruction to the first picture transmitting processor 15. This transmission instruction instructs that the picture data is transmitted to the rear monitor 24 at the data transfer rate of 10 Mbps. In response to this transmission instruction, the transmission-sided resource managing unit 64 of the first picture transmitting processor 15 transmits an acknowledgement signal for the transmission instruction to the first picture receiving processor 11, and controls both the encoder 62 and the communication IC 63 to output the picture data to the rear monitor 24 at the data transfer rate of 10 Mbps.

Next, in response to the acknowledgment signal for the transmission instruction sent from the first picture transmitting processor 15, the first picture receiving processor 11 sends a control signal to the fourth picture transmitting processor 18, and then, receives an acknowledgment signal for the control signal. This control signal controls the back-sight camera 28 in such a manner that the picture data is transmitted at the data transfer rate of 10 Mbps.

Next, the transmission-sided resource managing unit 64 of the fourth picture transmitting processor 18 performs such a control operation that the picture signal from the back-sight camera 28 is compressed to obtain picture data of 10 Mbps, and then, this picture data is transmitted to the first picture receiving processor 11.

As a result, in the on-vehicle picture data transmission system, even when the data transfer capacity of the cable 101 is smaller than or equal to 20 Mbps, the transmission bands through which the data are transmitted from the respective picture sources can be controlled.

Next, a description will now be made of another structural example of a picture transmitting processor.

The picture transmitting processor is connected to a plurality of picture sources, and performs an encode operation while vehicle information indicative of a condition of a vehicle, and also switch information formed by a user's operation are used as a parameter. This picture transmitting process operation has a function capable of performing a band control based upon the above-explained resource management process, and also another function capable of changing both a compression system and a compression ratio in response to the vehicle information, the switch information and a picture source to be transmitted.

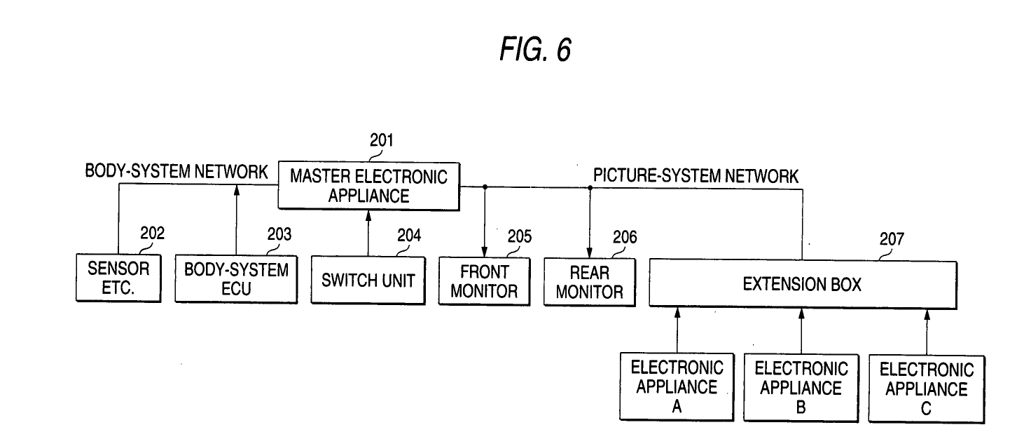

This picture transmitting processor is contained in such an on-vehicle picture data transmission system as shown in FIG. 6. This on-vehicle picture data transmission system is arranged in such a manner that a sensor 202, a body-system ECU 203, and a switch unit 204 are connected as a body-system network to a master electronic appliance 201, while a front-sided monitor 205, a rear-sided monitor 206, and an extension box 207 are connected as a picture-system network to this master electronic apparatus 201. In this case, the extension box 207 is connected to various sorts of electronic appliances (namely, electronic appliance “A” to electronic appliance “C”), and has a function which the above-explained picture transmitting processor has.

In this on-vehicle picture data transmission system, the vehicle information is inputted from the sensor 202 and the body-system ECU 203, which are present in the body-system network, via the master electronic appliance 201 to the extension box 207. Also, the switch information is inputted to the extension box 207. In this case, the sensor 202 senses, for example, a stop of the vehicle, a traveling speed of the vehicle, a traveling direction of the vehicle, an interval between two vehicles, a total passenger number. The switch unit 204 is constituted by an operation panel which is operated by a user. For example, this operation panel instructs switching of a picture source.

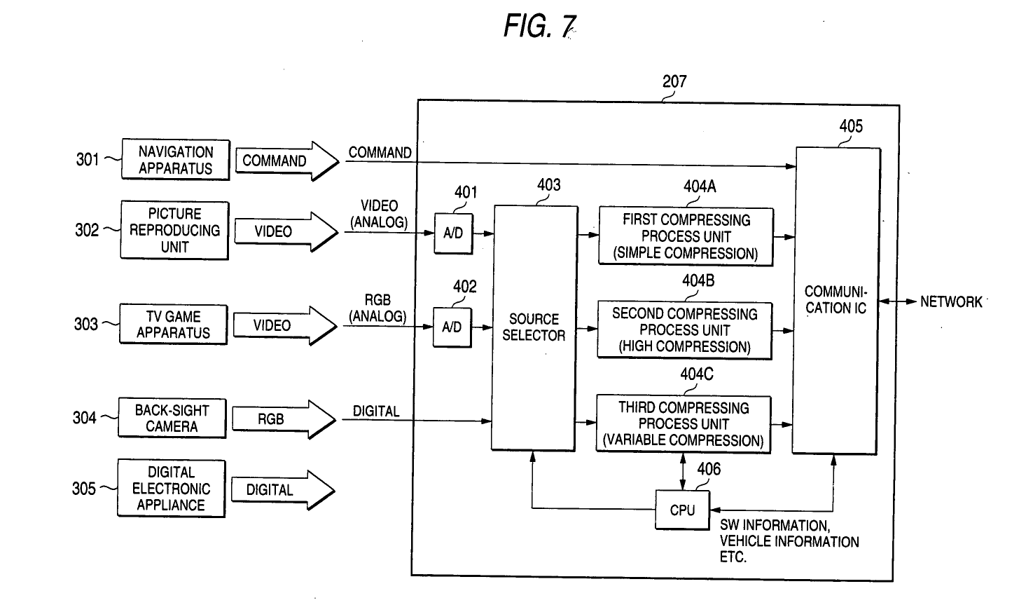

As indicated in FIG. 7, this extension box 207 is connected to a navigation apparatus 301, a picture reproducing unit 302, a game apparatus 303, a back-sight camera 304, and various sorts of digital electronic appliances 305. This extension box 207 comprises an A/D converting process unit 401, another A/D converting unit 402, a source selector 403, a first compressing process unit 404A, a second compressing process unit 404B, a third compressing process unit 404C, a communication IC 405, and a CPU (Central Processing Unit) 406. The A/D converting process unit 401 receives an analog picture signal from the navigation apparatus 301. The A/D converting process unit 402 receives an analog RGB signal from the picture reproducing unit 302. The communication IC 405 is connected to a network. The CPU 406 controls these units.

In this extension box 207, the first compressing process unit 404A performs a simple compressing process, namely a data compressing process operation such as a thinning process of line data. Also, the second compressing process unit 404B performs a high compressible process operation such as the MPEG (Moving Picture Experts Group) 4, and the third compressing process unit 404C performs a variable length compressible process operation such as the motion JPEG (Joint Photographic coding Experts Group) and the MPEG2.

This extension box 207 receives the vehicle information and the switch information from the communication IC 405, and inputs these received information into the CPU 406. As a result, based upon both the vehicle information and the switch information, the CPU 406 selects a desirable picture source, and outputs a selection control signal to the source selector 403. This selection control signal selects a compression system which is used when picture data is distributed. In response to this selection control signal, the source selector 403 recognizes the picture data from the A/D converting process unit 401, the picture data from the A/D converting process unit 402 and the picture date from the back-sigh camera 304. Then, the source selector 403 outputs the respective picture data to the first compressing process unit 404A, the second compressing process unit 404B or the third compression process unit 404C. Also, in such a case that the source selector selects the third compressing process unit 404C which executes the variable length compression of the picture data, the CPU 406 supplies a control signal for designating a compression ratio to the third compressing process unit 404C.

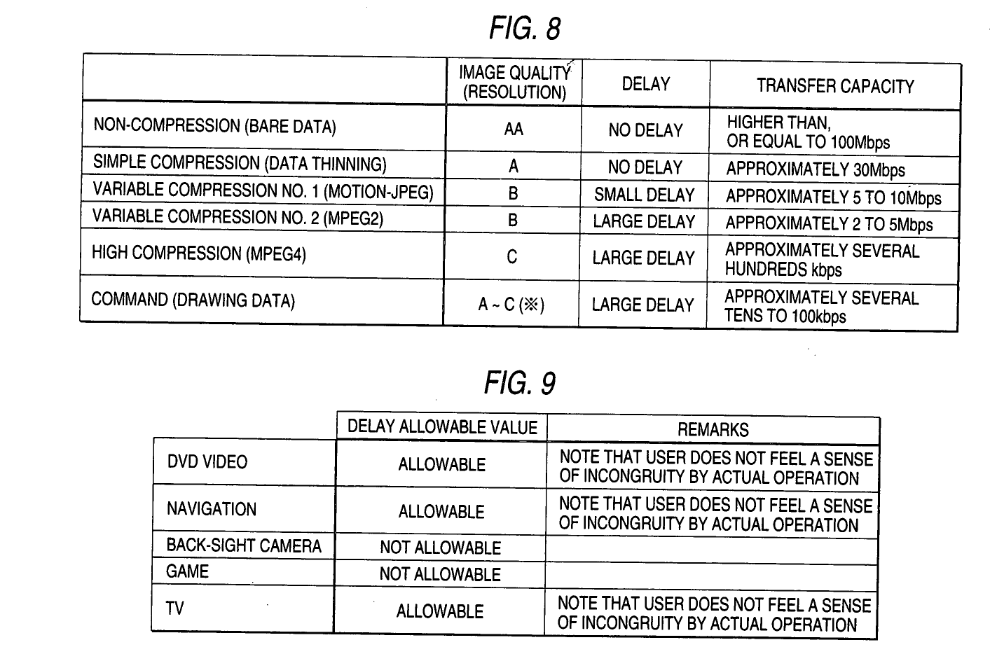

The CPU 406 recognizes an image quality, a transfer delay, and a transfer rate in each of compression systems shown in FIG. 8, so that the CPU 406 switches a picture source in accordance with switch information entered from the communication IC 405. Then, the CPU 406 switches a compression system based upon an image quality a transfer delay, and a transfer capacity, which are required from picture data.

The CPU 406 executes a control operation in such a manner that the compression system is switched based upon the switch information indicative of switching of the picture source. The CPU 406 executes the control operation in such a way that the compression system is switched based upon an image quality and a transfer delay allowable amount, which are required for the selected picture source. The CPU 406 stores the delay allowable values every picture source indicated in FIG. 9, so that this CPU 406 switches the compression system based upon the respective delay allowable values. The CPU 406 determines such a transmission band used when picture data is transferred in response to an empty range supplied from the master electronic appliance 201. In other words, the CPU 406 selects the compression system in such a manner that the CPU 406 uses a narrow transmission band in such a case that picture data is transmitted even when a transfer delay may be produced, whereas the CPU 406 uses a wide transmission band in such a case that picture data of such a picture source is transmitted while an occurrence of a transfer delay is not allowed.

Specifically, when the picture reproducing unit 302 is selected as CPU 406, the CPU 406 selects the compression system in such a manner that the picture data is compressed by way of the MPEG 2, and the compressed picture data is transmitted. When the navigation apparatus 301 is selected as the picture source, the CPU 406 selects the compression system in such a manner that the picture data is not compressed, and a command is transmitted. When the game apparatus 303 is selected as the picture source, the CPU 406 selects the compression system in such a manner that the picture data is compressed by way of the motion JPEG, and the compressed picture data is transmitted. When a television receiver is selected as the picture source, the CPU 406 selects the compression system in such a manner that the picture data is compressed byway of the MPEG 2, and the compressed picture data is transmitted.

In this case, the CPU 406 may change the compression ratio in response to an empty band of a cable. Specifically, in such a case that the CPU 406 transfers the picture data which is reproduced from the recording medium such as the DVD from the picture reproducing unit 302, this CPU 406 selects such a compression system capable of emphasizing the image quality. In the case that the CPU 406 switches the picture source in response to the switch information and is required to transfer the picture data from the game apparatus 303 and the digital electronic appliance 305, this CPU 406 switches the wide compression system into the narrow compression system whose transfer capacity is small (for example, MPEG4).

Alternatively, the CPU 406 may switch the compression systems in response to either a position of a monitor, or performance of a monitor. Specifically, the CPU 406 may switch the compression systems based upon the front monitor 205 arranged in front of the front seat of the vehicle, and the rear monitor 206 arranged in front of the rear seat. Specifically, in case that the image data is supplied from the picture producing unit 302, the game apparatus 303, and the digital electric appliance 305 such as a TV, the CPU 406 executes such a process operation that the image is not display on the front monitor 205, or the CPU 406 select the high compression system such as MPEG4 in order to perform a simple image displayed on the front monitor 205 and select the low compression system such as MPEG2 in order to display the picture data on the rear monitor 206 in the high image quality. In this case, the CPU 406 selects as to whether the picture is displayed on the front monitor 205, or the rear monitor 206 by operating the operation switches provided on the front monitor 205 and the rear monitor 206.

Furthermore, the CPU 406 performs such a process operation for switching a compression system based upon operation/non-operation of the switch unit 204, and/or a operation frequency of the switch unit 204. Specifically, since the navigation apparatus 301 does not correspond to such a picture source which continuously requires a switch operation, a delay is produced on the normal screen such as a map representation. However, only when the switch unit of the navigation apparatus 301 is operated, in particular, only when an immediate response is required while the display screen is scrolled, the CPU 406 switches the present compression system into either the thinning process operation or the compression system having small delays such as the motion JPEG. Also, in the case that the picture source corresponds to the game apparatus 303, or in the case that the display screen is scrolled, CPU 406 switches the compression system having the small delay.

Furthermore, the CPU 406 performs such a process operation for switching a compression system in response to vehicle information from the sensor 202 and the body-system ECU 203. As this vehicle information, there are provided a vehicle speed sensor signal and a parking brake signal from the sensor 202. The CPU 406 switches the compression system by judging a drive condition of a vehicle based upon the vehicle information. Specifically, in the case that the picture reproducing unit 202 and the game apparatus 303 are selected as the picture source, when the CPU 406 judges that the vehicle is driven under normal condition based upon the vehicle information, this CPU 406 controls in such a manner that the contents of the picture data is not displayed on the front monitor 205 in order to secure a driving safety characteristic of the vehicle, and the contents of the picture data is displayed in the high image quality while the vehicle is stopped.

Only when the back gear signal is inputted as the vehicle information, the CPU 406 judges that the picture data derived from the back-sight camera 304 is needed and then is transmitted. Also, in such a case that the CPU 406 selects the back-sight camera 304 as the picture source, since the allowed transfer delay amount is changed according to the vehicle speed, the CPU 406 selects the MPEG 2 compression system based upon the vehicle information while the vehicle is driven at low speeds, whereas the CPU 406 selects the motion JPEG compression system based upon the vehicle information while the vehicle is driven in high speeds. In this MPEG2 compression system, although the transfer delay is large, the transfer rate is small. In the motion JPEG compression system, the transfer delay is small.

Moreover, the CPU 406 may select the compression system by recognizing an interval between successively-driven vehicles based upon vehicle information detected by a sensor for sensing an interval between successively-driven vehicles. Specifically, in such a case that the CPU 406 selects the back-sight camera 304 as the picture source and displays the contents of the picture data on the monitor, when the interval between the successively-driven vehicles is long, this CPU 406 selects the MPEG2 compression system in which although the transfer delay is large, the transfer capacity is small, when the interval between the successively-driven vehicles is short, the CPU 406 selects the motion JPEG compression system in which the transfer delay is small.

Moreover, the CPU 406 may switch the compression systems in response to externally supplied information. In this case, as the externally-supplied information, the following signals may be employed, for example, a signal supplied from a telephone line, an analog picture signal from a general-purpose analog picture interface, and a digital picture signal from a general-purpose digital picture interface such as IEEE (The Institute of Electrical and Electronics Engineers) 1394. Specifically, in the case that the CPU 406 must display a contents of picture data on the monitor at a top priority in response to externally-supplied urgent information, the CPU 406 switches the picture sources in such a manner that this urgent image (navigation image and camera image etc.) is displayed, and performs the non-compression process operation, the thinning process operation, or the motion JPEG process operation with this respect to this urgent picture data to display the contents of the processed urgent picture data in the high image quality on the monitor. In response to this operation, the CPU 406 lowers the priority degree of the other picture under transfer operation, and then, executes the compression process operation by the MPEG4 with respect to the picture having the low priority degree, so that this picture is displayed in the simple image display manner.

In addition, the CPU 406 may change the compression systems in response to such vehicle information indicative of a total passenger number of a vehicle, which is detected by the sensor 202. Specifically, for example, when there is no passenger on the rear seat side, the rear monitor 206 selects such a compression system to display a picture on the front monitor 205 in a high image quality.

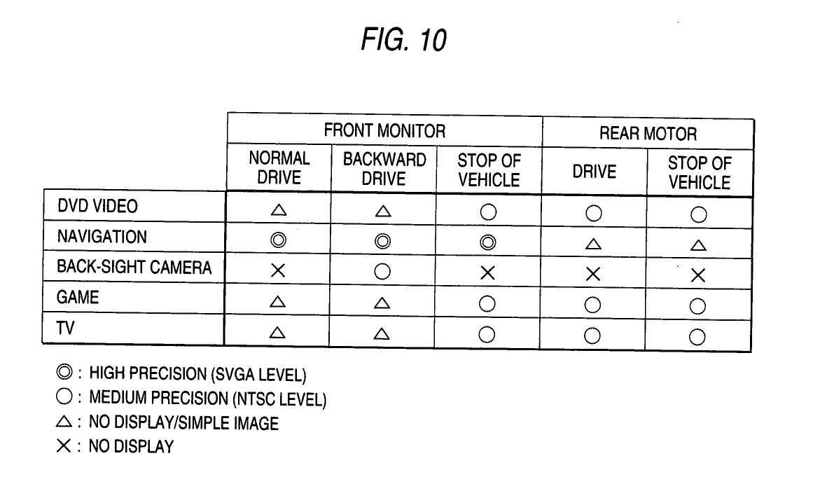

As explained above, in the extension box 207 for executing such a process operation, not only the picture source is determined based upon the switch information and the vehicle information, but also the compression systems and the compression ratios of the respective picture sources may be determined based on a plurality of parameters. This example will now be explained with reference to FIG. 10.

While a contents of picture data is displayed on the front monitor 205 and the rear monitor 206, the CPU 406 recognizes a driving condition (see FIG. 10) of a vehicle based upon vehicle information, and changes image qualities which are required with respect to each of picture sources. The image qualities (resolution power) shown in FIG. 8 are defined from a high image quality up to a low image quality in this order of A, B, C. Symbol “⊚” indicates high precision, symbol “∘” shows medium precision, symbol “Δ” represents either no display or a simple image, and symbol “X” denotes no display. That is, when the CPU 406 judges that the vehicle is driven under normal drive condition based upon the vehicle information, the CPU 406 controls the source selector 403 in such a manner that this CPU 406 selects such a compression system used to display the image on the front monitor 205 in the high precision, and also selects such a compression system used to display the image on the rear monitor 206 in the simple image mode.

In accordance with such an extension box 207, the picture data can be transferred even in the network, the transfer rate of which is limited. Also, the compression system can be automatically selected based upon the switch information produced by the switch operation by the user and the vehicle information made by the condition of the vehicle, so that the images quality of the picture data which is required to drive the vehicle can be maintained in high levels. As a consequence, in accordance with this extension box 207, while the image qualities and also the total channel number of the picture data are secured in response to the changes in the vehicles and the users, the pictures can be transferred in a high efficiency.

1-4. (canceled)

5. An on-vehicle picture data transmitting apparatus comprising:
a picture input unit for inputting picture data supplied from a plurality of picture sources which are externally connected;
a transmission reception unit for receiving vehicle information indicative of a condition of a vehicle, and for transmitting picture data via a communication line to a picture display apparatus;
a compressing processor having a plurality of compressing process units, compression systems of which are different from each other;
a selection unit for receiving a plurality of picture data from the picture input unit, and for selectively outputting the picture data from the picture source designated based upon a picture source selection signal to the compressing process unit in response to a compression selection signal; and
a controller for producing the picture source selection signal and the compression selection signal and controlling the compression system based upon the vehicle information to control the selection unit.

6. The on-vehicle picture data transmitting apparatus according to claim 5, wherein
the controller produces the compression selection signal for each of the picture data based upon an image quality required for each of the picture sources.

7. The on-vehicle picture data transmitting apparatus according to claim 5, wherein
the transmission reception unit is connected to a master electronic appliance for monitoring a communication traffic within the vehicle, and receives vehicle information indicative of a communication traffic of a communication line from the master electronic appliance contained in a network; and
the controller produces the compression selection signal for switch the compression systems of the respective picture data based upon the vehicle information indicative of the communication traffic received from the transmission reception unit.

8. The on-vehicle picture data transmitting apparatus according to claim 5, wherein
the controller produces the compression selection signal for switching the compression system of the picture data based upon a setting position of the picture display apparatus.

9. The on-vehicle picture data transmitting apparatus according to claim 5, wherein
the transmission reception unit is connected to an operation input device which is operated by a user in the vehicle, and receives an operation input signal supplied from the operation input device, and
the controller produces the picture source selection signal and the compression selection signal based upon the operation input signal to control the selection unit.

10. The on-vehicle picture data transmitting apparatus according to claim 5, wherein
the transmission reception unit is connected to a sensor for sensing a condition of the vehicle; and
the controller produces the compression selection signal based upon a sensor signal from the sensor.

11. The on-vehicle picture data transmitting apparatus according to claim 5, wherein
the controller produces the compression selection signal for switching the compression system based upon vehicle information indicative of a drive condition of the vehicle.
